(19) United States
(12) Patent Application Publication
(10) Pub. No.: US 2025/0389109 A1
(43) Pub. Date: Dec. 25, 2025

(54) ADAPTER FOR A SANITARY BASIN ACCESSORY, SANITARY PART, AND SYSTEM

(71) Applicant: BLANCO GMBH + CO KG, Oberderdingen (DE)

(72) Inventors: Mikhail Lebedkin, Kraichtal (DE); Jens Hütter, Oberderdingen (DE); Marco Flaig, Stuttgart (DE); Georg Kahl-Marburger, Neckarsulm (DE); Thomas Funke, Eppingen (DE)

(73) Assignee: BLANCO GMBH + CO KG, Oberderdingen (DE)

(21) Appl. No.: 19/240,180

(22) Filed: Jun. 17, 2025

(30) Foreign Application Priority Data
Jun. 21, 2024 (DE) 10 2024 205 814.9

(51) Int. Cl. E03C 1/186; A47J 47/20

(52) U.S. Cl. CPC E03C 1/186; A47J 47/20

(57) ABSTRACT

An adapter for an accessory part of a sanitary basin, in particular for an accessory part of a sink, is provided comprising a holder to hold the accessory part and at least two shelves each having an extension for resting on and/or bearing against at least one sloped edge of the sanitary basin, whereby a maximum reach of at least one of the extensions defines a direction along which the reach of the at least one extension is smaller than the reach of the adapter in the same direction.

The invention relates to an adapter for an accessory part of a sanitary basin, comprising a receiving device for receiving the accessory part.

The invention further relates to a sanitary part comprising an adapter.

The invention also relates to a system comprising at least one sanitary part and at least one further accessory part.

The invention also relates to a sanitary basin with a system.

Although the invention is generally applicable to adapters for accessories of sanitary basins, the following invention is explained with reference to adapters for accessories of kitchen sinks.

For kitchen sinks, it has become common practice to provide accessories that are placed on top of the kitchen sink. For example, these accessories can be arranged on surrounding edges in the kitchen sink. Several circumferential edges can be provided at different heights so that several accessory parts can be moved against and/or over each other, as is known, for example, from US 2015/0067962 A1.

However, the disadvantage of such a design is that several steps have to be provided for the surrounding edges, which increases the space required for the kitchen sink. In addition, the production is complex.

WO 2023/034981 A1 provides multiple accessory parts on a common surrounding edge. However, these require more space, as the accessories are arranged next to each other on the surrounding edge. However, if the accessories are arranged on top of each other, only the lowest accessory has a secure hold, as the other accessories may rest on the lower accessories and slip vertically along the edge. This arrangement also requires more space, as the accessories are stacked vertically. In addition, the lower accessories must not be very tall in height.

It is therefore a goal of this invention to provide an adapter for an accessory part of a sanitary basin, which can be arranged on a sanitary basin together with other accessory parts and/or sanitary parts in a simple and space-saving manner. The adapter for the accessory should also be versatile. A further goal of this invention is to provide a sanitary part, a system comprising one sanitary part and a further accessory part, and a sanitary basin, whereby it is possible to arrange the accessory parts in a simple and compact way.

A further goal of this invention is to provide an alternative adapter for an accessory part, an alternative sanitary part, an alternative system and an alternative sanitary basin.

In one embodiment, this invention solves the above-mentioned goals with an adapter for an accessory part of a sanitary basin, in particular for an accessory part of a sink, comprising a holder to hold the accessory part and at least two contact elements, each with an extension to stack or rest one against at least one, but most importantly inclined, edge of the sanitary basin, whereby at least one of the extensions' maximum reach defines a direction along which the reach of at least one adapter is smaller than the adapter's reach in the same direction.

In one embodiment, this invention achieves the aforementioned goals with a sanitary part comprising an adapter according to any one of claims 1 to 10, wherein an accessory part of a sanitary basin is arranged on and/or in the holder.

In one embodiment, this invention achieves the aforementioned goals with a system comprising at least one sanitary part according to claim 11 and at least one further accessory part, wherein the further accessory part comprises a working surface and at least two, but preferably four, feet arranged on a bottom of the working surface, with a clearance provided between two feet in one direction, which extends in that direction further than a contact element and/or the adapter does in the same direction.

In one embodiment, this invention achieves the aforementioned goals with a sanitary basin, in particular a sink, with a system according to claim 12, wherein the sanitary basin comprises an initial shelf and a second, whereby the first shelf is arranged opposite the second shelf.

One of the advantages of this is that the accessories can be arranged with much more flexibility. Furthermore, other accessories can be easily arranged above the adapter in addition to accessories in the adapter, while ensuring a secure placement on the sanitary basin. Another advantage is that the adapter and other accessories can be positioned on the washbasin to save space.

The term “inclined” is to be understood in the broadest sense and refers, in particular in the description, preferably in the claims, to a surface which is at an angle greater than 0 degrees and less than 90 degrees to a plane along the two maximum reaches of the adapter. This means, a surface that is arranged at an angle greater than 0 degrees and less than 90 degrees to a horizontal surface or floor when the adapter is arranged on the surface or floor.

Further features, advantages and further embodiments of the invention are described or disclosed below.

According to a preferred embodiment of the invention, the adapter has a rectangular frame; the frame comprising at least two cross members and at least two longitudinal members. The frame can serve as the basic structure of the adapter, on which the holder and the contact elements are fixed. One advantage of this is that the adapter can be positioned on different sanitary basins and that various accessories can be attached to the adapter.

According to another preferred embodiment of the invention, the contact elements are each arranged on a cross member. In particular, the contact elements can be connected to the cross member in one piece. One advantage of this is that the contact elements can also be used as a handle for the adapter.

According to another preferred embodiment of the invention, the contact elements each comprise a projection, which in turn is inclined, with one of the extensions arranged on one of the projections in each case. In this case, the extensions can be arranged on a horizontal plane of the sanitary basin. One advantage of this is that the adapter can be securely positioned on the sanitary basin. In addition, the extensions can be provided as a reliable handle for a user.

According to another preferred embodiment of the invention, the holder comprises at least one internal projection, which is rounded, and arranged in a corner area of the frame. The internal projections can be uniform in shape. This means that an accessory can be securely inserted into the adapter and fixed there in a detachable manner. One advantage of this is that the accessory can be easily arranged and replaced in the adapter.

According to another preferred embodiment of the invention, the frame and/or at least one of the contact elements is made of stainless steel and/or plastic. The benefit of this is that the adapter is both stable and waterproof.

According to another preferred embodiment of the invention, the cross-members and/or the contact elements are overmolded with a plastic. It is conceivable that the contact elements are partially or completely overmolded with plastic. One advantage of this is that adhesion between the adapter and a sanitary basin is increased.

According to another preferred embodiment of the invention, the extensions have a parallel top and bottom, or the extensions each have a top and a bottom which taper towards one another at the same angle to a main reach direction, with the top and bottom each having the same horizontal reach. An angle between a projection and an arranged extension can be the same as an angle between the frame of the adapter and the projection. One advantage of this is that the top and bottom of the adapter can be positioned on the sanitary basin. In other words, the adapter can be turned upside down and also placed on the sanitary basin when turned upside down. The connection with the slopes of the projections allows the adapter frame to be positioned at two different heights on the sanitary basin.

It is also conceivable that the top and bottom of the extensions are not parallel, but are both arranged at an angle to the main reach direction. The top and bottom can taper towards each other and form the same angle with the main reach direction. One advantage of this is that both the top and the bottom of the adapter can be positioned on the sloping edge of a sink.

According to another preferred embodiment of the invention, the adapter is designed to be stackable, so that two adapters can be stacked on top of each other, the total height of which is less than the sum of their individual heights. The slopes of the projections can be designed in such a way that the frames of the adapters are adjacent to each other when the adapters are stacked. One advantage of this is that it takes up less space when storing multiple adapters.

According to another preferred embodiment of the invention, the holder is designed to hold the accessory part on the holder's top and bottom. The inner projections can be thinner, i.e. essentially a vertical reach, than the frame and be arranged centrally between the frame's top and bottom. In this way, the accessory can be placed on the holder from both sides of the adapter. One advantage of this is that an accessory can also be placed on or in the adapter when the adapter is turned upside down.

According to another preferred embodiment of the invention, the adapter is designed to be in contact with the sanitary basin only with the extensions lying down, with adapter resting with the extensions on the first and second holding surface. In other words, when the adapter is in place, there is a gap between the slopes of the projections and the corresponding slopes of the sanitary basin. One advantage of this is that the adapter is easy to insert into the sanitary basin and can be moved along the sanitary basin.

Further important features and advantages of the invention can be seen in the sub-claims, the drawings and the related illustration captions with reference to the drawings.

It is understood that the features mentioned above and those to be explained below can be used not only in the combination indicated in each case, but also in other combinations or on their own, without departing from the scope of this invention.

Preferred designs and embodiments of this invention are shown in the drawings and are explained in more detail in the following, with identical references referring to identical or similar or functionally identical components or elements.

As such,

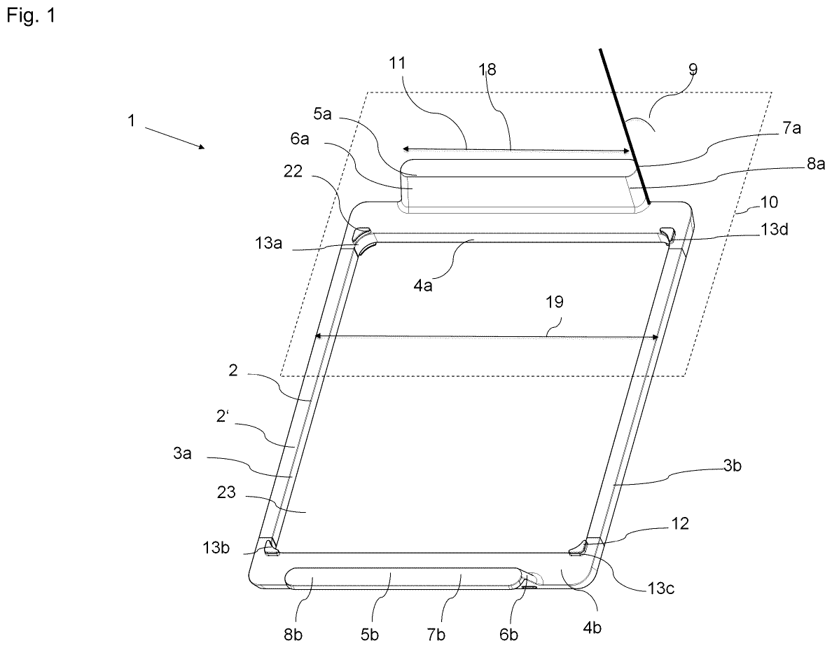

FIG. 1 shows a diagram of an adapter according to one embodiment of this invention;

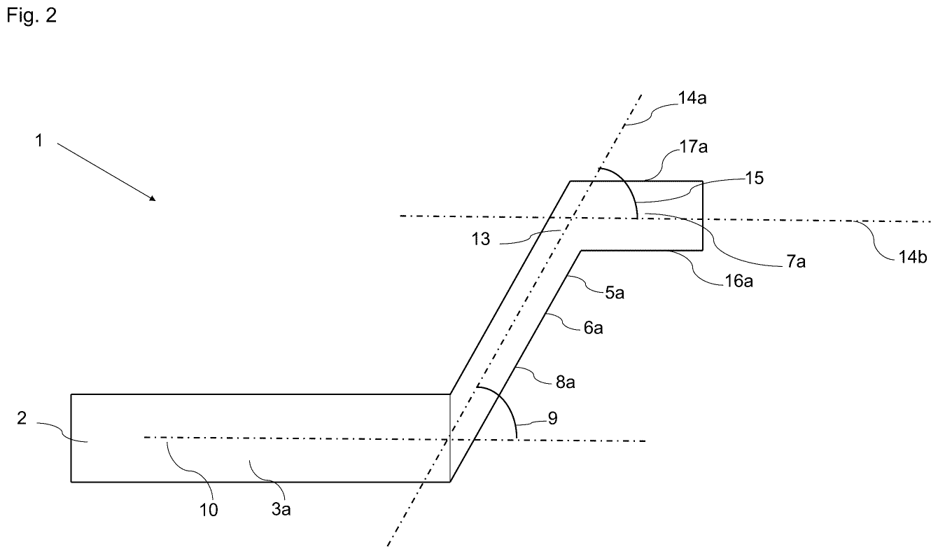

FIG. 2 shows a cross-section of the adapter according to FIG. 1 under one embodiment of this invention;

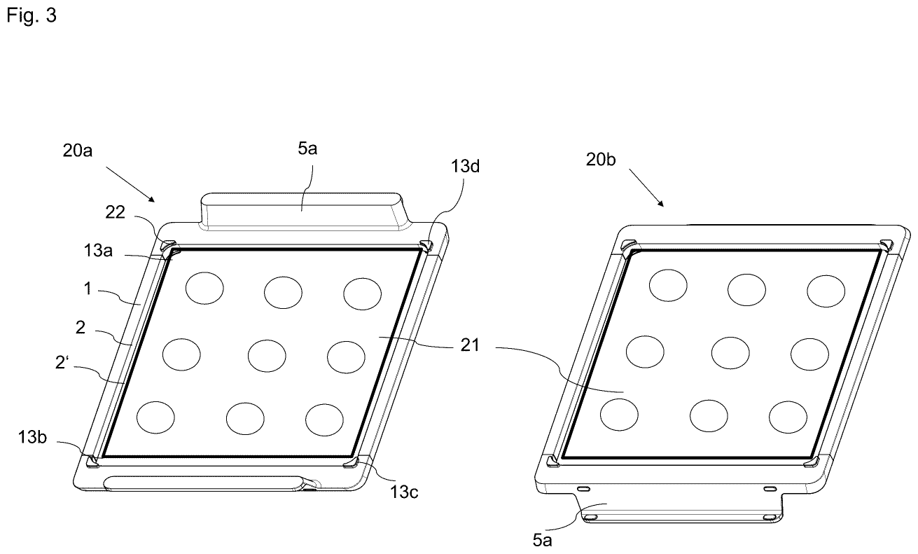

FIG. 3 shows a sanitary part in two arrangements of the adapter according to one embodiment of this invention;

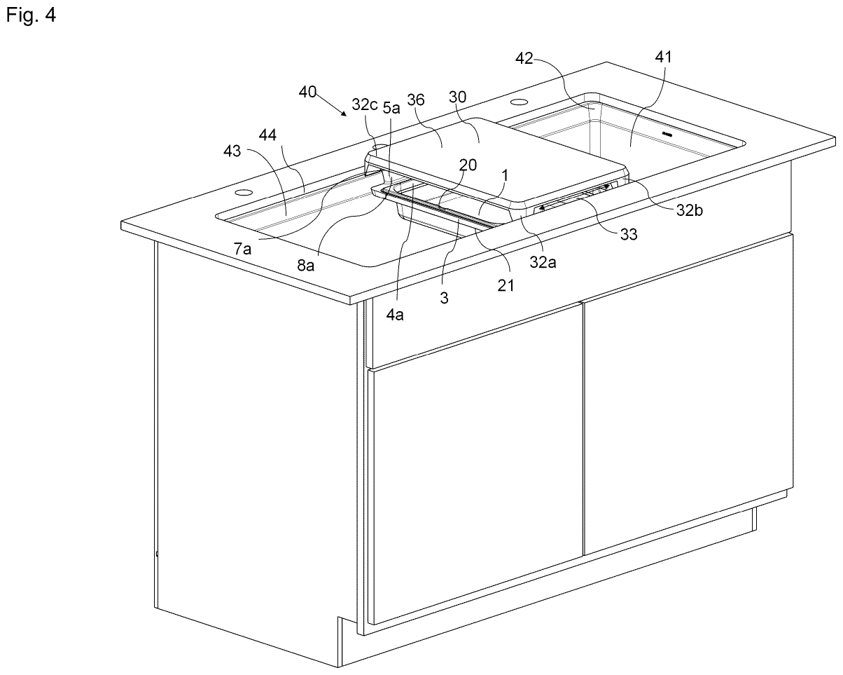

FIG. 4 shows a sanitary basin in another embodiment of this invention; and

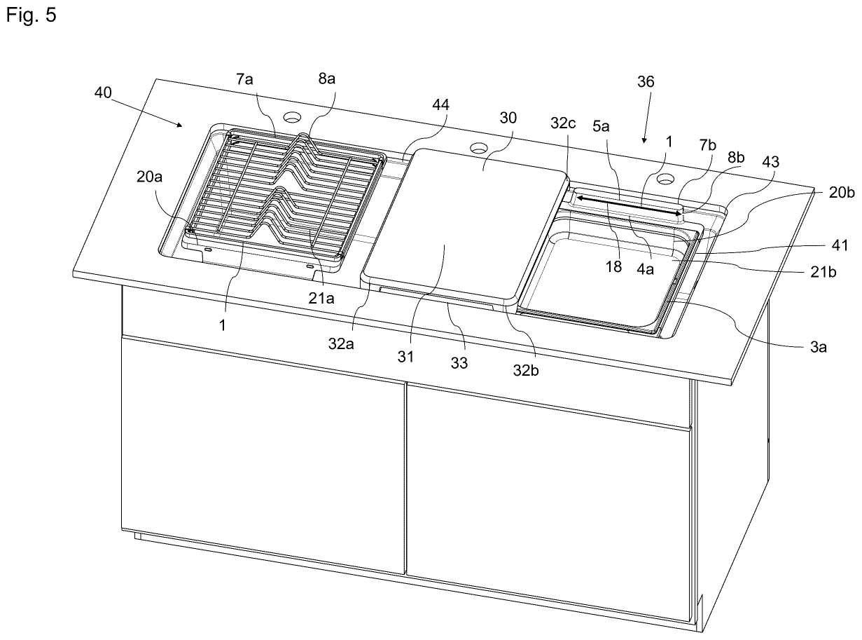

FIG. 5 shows a sanitary basin under another embodiment of this invention.

FIG. 1 shows a diagram of an adapter according to one embodiment of this invention.

Adapter 1 comprises an essentially rectangular frame 2. Frame 2 is formed by two longitudinal struts 3a, 3b and two transverse struts 4a, 4b and comprises a free space 23 within the longitudinal and transverse struts 3a, 3b, 4a; 4b. Contact element 5a, 5b is arranged on each of the cross struts 4a, 4b, with each contact element 5a, 5b comprising an extension 7a, 7b and a projection 6a, 6b. Projections 6a, 6b are rectangular in shape and are arranged along the entire length of cross struts 4a, 4b. It is also conceivable that projections 6a, 6b on cross struts 4a, 4b are only arranged on a partial section of projections 6a, 6b. For example, projections 6a, 6b can have an opening and be arranged only near the ends of projections 6a, 6b on cross struts 3a, 3b. Projections 6a, 6b are also sloped 8a, 8b. This means that projections 6a, 6b extend away from frame 2 at an angle 9 from a plane 10 through the frame 2. Angle 9 can be between 25° and 89°, preferably between 45° and 80°, mainly between 65° and 80°. Angle 9 allows multiple adapters 1 to be stacked inside each other. Adapters 1 can be stacked inside each other in such a way that their frames 2 rest on top of each other.

Extensions 7a, 7b are rectangular in shape and are arranged along the entire length of projections 6a, 6b. The length of extensions 7a, 7b matches that of projections 6a, 6b.

Contact elements 5a, 5b each have a maximum reach 18, which defines direction 11. In particular, direction 11 is oriented parallel to cross struts 4a, 4b. Reach 18 of contact elements 5a, 5b in direction 11 is smaller here than reach 19 of adapter 1 in the same direction 11. Reach 18 of contact elements 5a, 5b in direction 11 is less than a reach of cross struts 4a, 4b in the same direction. In other words, contact elements 5a, 5b are arranged on cross struts 4a, 4b only over a partial area of cross struts 4a, 4b.

It is also conceivable that contact elements 5a, 5b do not comprise any first projections 6a, 6b, but only extensions 7a, 7b. In this case, projections 7a, 7b are rectangular in shape and are sloped, as are projections 6a, 6b. In this case, adapter 1 can therefore be arranged on the incline of a kitchen sink, as extensions 7a, 7b can rest directly on it.

Extensions 7a, 7b have a smaller reach in direction 11 than the reach of cross struts 4a, 4b in the same direction.

Holder 12, in this case with inner projections 13a-d, is formed on or in the corner areas of frame 2. Holder 12 is designed to hold an accessory. Inner projections 13a-d are thinner than frame 2 and are arranged centrally in relation to the thickness of frame 2, measured perpendicular to plane 10 of frame 2. This means that a step 22 is formed between the top 2′ of frame 2 and inner projections 13a-d, and/or that a step (not shown) is formed between a bottom of the frame (not shown) and inner projections 13a-d. The inner projections 13a-d are essentially in the form of a rounded triangle, each of which is arranged with one edge on transverse strut 4a, 4b and with a further edge on longitudinal strut 3a, 3b.

Frame 2 and/or contact elements 5a, 5b can be made of stainless steel, whereby contact elements 5a, 5b and/or cross struts 4a, 4b can be overmolded with plastic.

FIG. 2 shows a diagram of a cross-section of the adapter according to FIG. 1 according to one embodiment of this invention.

FIG. 2 shows a front view of a section of adapter 1 shown in FIG. 1. Extension 7a is arranged on projection 6a. Projection 6a comprises slope 8a. This means that a maximum reach direction 14a of projection 6a has angle 9 with plane 10 along longitudinal strut 3a and/or along frame 2. Slope 8a serves to provide a stop for adapter 1 when adapter 1 is inserted into a sanitary basin. The sanitary basin can have a slope corresponding to slope 8a, against which slope 8a can rest. Furthermore, slope 8a creates a height difference between extension 7a and longitudinal member 3a. Due to the difference in height, extension 7a can be used as a handle to lift adapter 1.

Extension 7a extends along a maximum reach direction 14b. In particular, extension 7a extends in such a way that angle 15 between reach direction 14a of projection 6a and reach direction 14b of extension 7a corresponds approximately to angle 9 between reach direction 14a of projection 6a and plane 10 of longitudinal strut 3a. In other words, the reach direction 14b of extension 7a is essentially parallel to plane 10. Thus, adapter 1 can be arranged on a corresponding horizontal step of a sanitary basin (see FIGS. 4 and 5) by means of bottom 16a of extension 7a. It is also possible to turn adapter 1 around and place adapter 1 with top 17a of extension 7a on a sanitary basin. It is also conceivable that bottom 16a and top 17a of extension 7a are not parallel, but both arranged at an angle to the main reach direction 14b. Top 17a and bottom 16a can taper towards each other and form the same angle with the main reach direction 14b, so that adapter 1 can be arranged with both top 17a and bottom 16a on an inclined edge of a sink.

A second contact element 5b (not shown) can be designed in the same way as contact element 5a shown in FIG. 2.

FIG. 3 shows a diagram of a sanitary part in two arrangements of the adapter according to one embodiment of this invention.

FIG. 3 shows two arrangements of a sanitary part 20a, 20b. The sanitary part 20a comprises an adapter 1 as shown in FIG. 1. An accessory 21, for example a sieve, is arranged on the inner projections 13a-d. Accessory 21 rests on inner projections 13a-d. Since projections 13a-d are not flush with the top 2′ of adapter 1, a step 22 is created between projections 13a-d and frame 2 of adapter 1. Accessory 21 can thus be inserted into frame 2 and is held from below by inner projections 13a-d and laterally by frame 2.

In contrast to sanitary part 20a, sanitary part 20b is shown in an inverted variant, i.e. the contact part 5a of sanitary part 20b is oriented in the opposite direction to contact part 5a of sanitary part 20a. Accessory part 21 is also placed on projections 13a-d in sanitary part 20b, but on the opposite side compared to the arrangement according to sanitary part 20a. This means that accessory 21 can be arranged on both sides of inner projections 13a-d. The same accessory part 21 can be arranged in both arrangements of sanitary parts 20a, 20b.

FIG. 4 shows a sanitary basin according to one embodiment of this invention.

Sanitary basin 40 comprises a basin 41 for holding dishes, rinsing water or the like, whereby basin 41 has a surrounding area 42. Surrounding area 42 is on a top of the basin 41 and comprises slope 43 and horizontal shelf 44 adjacent to slope 43. Horizontal shelf 44 is formed along the entire surround of basin 41. It is also conceivable that horizontal shelf 44 comprises an initial shelf then a second shelf arranged opposite the first, arranged separately from one another.

System 36 is arranged on horizontal shelf 44. System 36 comprises sanitary part 20, in particular a sanitary part as shown in FIG. 3, and a further accessory part 30 in the form of a cutting board. The sanitary part 20 in turn comprises adapter 1 with contact element 5a, whereby adapter 1 can be designed in accordance with adapter 1 shown in FIG. 1. Contact element 5 rests with extension 7a on horizontal shelf 44 and rests with slope 8a on slope 43 of basin 41. Slope 43 of basin 41 corresponds to slope 8a of adapter 1. In other words, slope 43 of basin 41 and slope 8a of adapter 1 are arranged parallel to each other. It is conceivable that slope 8a of adapter 1 is not directly adjacent to slope 43 of basin 41, but is spaced apart from it. In other words, a gap is provided between slope 8a of adapter 1 and slope 43 of basin 41.

The additional accessory 30 also rests on shelf 44; feet 32a-d are arranged on shelf 44 (foot 32d is not shown). Other accessory part 30 is arranged above sanitary part 20. This is possible because clearance 33 between feet 32a, 32b or between feet 32c, 32d is larger than the reach of contact element 5 in the direction of cross strut 4a. This also applies in particular to the opposite contact element. In this way, additional accessory part 30 can be arranged above sanitary part 20 and at the same time rest directly on basin 41, in particular the shelf 44. In this state, additional accessory 30 has a direct purpose, for example for cutting vegetables. At the same time, it requires little additional space as it is positioned directly above sanitary part 20. Alternatively, it can be arranged next to sanitary part 20 so that both sanitary part 20 and other accessory part 30 can be used. However, it is particularly not possible for additional accessory part 30 to slide over sanitary part 20 along shelf 44.

It is also conceivable that contact element 5 does not rest with extension 7a on horizontal shelf 44, but instead rests with slope 8a of the adapter on slope 43 of basin 41. In this case, slope 8a of the adapter can have a smaller reach than adapter 1 so that the additional accessory can still be placed over adapter 1.

Additional accessory part 30 and sanitary part 20 have the same reach along one direction of the maximum reach of a longitudinal member 3 of adapter 1 of sanitary part 20. It is conceivable that additional accessory part 30 and sanitary part 20 have the same reach along one direction of the maximum reach of cross-member 4a.

FIG. 5 shows another sanitary basin according to one embodiment of this invention.

FIG. 5 shows sanitary basin 40, which can correspond to sanitary basin 40 shown in FIG. 4. System 36 comprising additional accessory part 30 and two sanitary parts 20a, 20b is shown on sanitary basin 40. Sanitary parts 20a, 20b each comprise an adapter 1 and an accessory part 21a, 21b in the form of a draining board or tray. Adapter 1 of sanitary part 20a can match adapter 1 of sanitary part 20b.

In a first embodiment, adapter 1 of sanitary part 20b is arranged on shelf 44. Extension 7b of sanitary part 20b rests on shelf 44 and slope 8b of sanitary part 20b is arranged on slope 43 of basin 41.

In a second embodiment, adapter 1 of sanitary part 20a is arranged on shelf 44. An extension of sanitary part 20a rests on shelf 44, but slope 8a of sanitary part 20a is not arranged on slope 43 of basin 41. As a result, accessory part 21a of sanitary part 20a is arranged higher than accessory part 21b of sanitary part 20b. Thus, two different heights of accessory 21a, 21b can be realized with one adapter 1. Adapter 1 allows accessories 21a, 21b to be arranged at different heights without requiring shelves 44 of different heights.

Additional accessory 30 comprises a substantially rectangular working surface 31, here in the form of worktop 31, and four feet, whereby only three feet 32a, 32b, 32c are shown in FIG. 5. Feet 32a, 32b, 32c are arranged on a bottom of worktop 31. Additional accessory 30 can be designed in the form of a cutting board.

Adapter 1 comprises a contact element 5a, which has a maximum reach 18, the maximum reach 18 extending parallel to cross strut 4a of adapter 1. Additional accessory part 30 comprises a clearance 33 between feet 32a, 32b, which extends along the direction of maximum reach 18 and is larger than maximum reach 18 of contact element 5a. In other words, free space 33 between feet 32a, 32b is larger than contact element 5a. This means that additional accessory 30 can be positioned above adapter 1 without additional accessory 30 resting on contact element 5a. Additional accessory part 30 can be arranged above sanitary part 20 in such a way that the two feet 32a, 32b are each located on different sides of contact element 5a and do not rest on contact element 5a. Additional accessory part 30 and sanitary part 20a, 20b can be moved together, since moving accessory part 30 directly causes sanitary part 20a, 20b to move.

In summary, at least one embodiment of this invention may have at least one of the following features and/or provide at least one of the following advantages:
Space-saving arrangement of various accessories.
Safe arrangement of various accessories.
Arrangement of accessories at different heights.

Although this invention has been described with reference to preferred designs, it is not limited thereto, but can be modified in a variety of ways.
1 Adapter
2 Frame
2′ Top of the frame
3, 3a, 3b Longitudinal strut
4a, 4b Cross brace
5, 5a, 5b System element
6a, 6b Projections
7a, 7b Extensions
8, 8a, 8b Slope
9 Angle
10 Level
11 Direction
12 Holder
13a, 13b, 13c, 13d Inner projections
14a, 14b Reach direction
15 Angle
16a Bottom
17a Top
18 Reach of the system elements
19 Reach of the adapter
20, 20a, 20b Sanitary part
21, 21a, 21b Accessory part
22 Level
23 Clearance
30 Accessory part
31 Worktop
32a, 32b, 32c, 32d Feet
33 Clearance
36 System
40 Sanitary basin
41 Basin
42 Surrounding area
43 Slope of the surrounding area
44 Horizontal holder

1. An adapter for an accessory part of a sanitary basin, in particular for an accessory part of a sink, comprising a holder to hold the accessory part and at least two contact elements each having an extension for resting on and/or bearing against at least one sloping edge of the sanitary basin, a maximum reach of at least one of the extensions defining a direction along which the sloped edge of the sanitary basin, wherein a maximum reach of at least one of the extensions defines a direction along which the reach of the at least one extension is smaller than the reach of the adapter in the same direction.

2. The adapter according to claim 1, characterized in that the adapter has a substantially rectangular frame, the frame comprising at least two cross members and at least two longitudinal members in each case.

3. The adapter according to claim 2, characterized in that the contact elements are each arranged on a cross member.

4. The adapter according to claim 1, characterized in that the contact elements each comprise a projection, which in particular each has a slope, one of the extensions being arranged on one of the projections in each case.

5. The adapter according to claim 2, characterized in that the holder comprises at least one inner projection, wherein the inner projection is rounded and arranged in a corner area of the frame.

6. The adapter according to claim 2, characterized in that the frame and/or at least one of the contact elements is made of stainless steel and/or plastic.

7. The adapter according to claim 2, characterized in that the cross members and/or the contact elements are plastic-coated.

8. The adapter according to claim 1, characterized in that the extensions have a top and a bottom parallel thereto, or in that extensions have a top and a bottom, which in each case run towards one another at the same angle to a main reach direction of the extensions, whereby the top and the bottom in each case have the same horizontal reach.

9. The adapter according to claim 1, characterized in that the adapter is designed to be stackable, so that two adapters can be stacked on top of one another, the total height of which is less than the sum of their individual heights.

10. The adapter according to claim 1, characterized in that the holder is designed to hold the accessory part on the top and bottom of the holder.

11. A sanitary part comprising an adapter according to claim 1, whereby an accessory part of a sanitary basin is arranged on and/or in the holder.

12. A system comprising at least one sanitary part according to claim 11 and at least one further accessory part, whereby the further accessory part comprises a working surface and at least two, preferably four, feet arranged on a bottom of the working surface, whereby a clearance is provided between two feet in one direction; the reach of this clearance in the direction is greater than a reach of a holder and/or an extension of the adapter in the direction.

13. A sanitary basin, in particular a sink, with a system according to claim 12, wherein the sanitary basin comprises an initial shelf and a second shelf, whereby the first shelf is arranged opposite the second shelf.

14. The sanitary basin according to claim 13, characterized in that the adapter is designed to rest, whereby the adapter with the extensions rests on the first and second shelves only to be in contact with the sanitary basin with extensions.
